(19) United States
(12) Patent Application Publication
(10) Pub. No.: US 2001/0013189 A1
(43) Pub. Date: Aug. 16, 2001

(54) Hierarchial wayfinding sign system and method

(76) Inventor: Robert Firth, Pittsburgh, PA (US)

Correspondence Address: Ansel M Schwartz, One Sterling Plaza, 201 N Craig Street, Suite 304, Pittsburgh, PA, 15213, US

(21) Appl. No.: 09/490,364

(22) Filed: Jan. 24, 2000

Related U.S. Application Data
(63) Continuation of application No. 09/008,985, filed on Jan. 20, 1998, now abandoned.

(51) Int. Cl. G09F 1/00

(52) U.S. Cl. 40/612

(57) ABSTRACT

The present invention is a hierarchical wayfinding sign system. The sign system comprises a plurality of area-finder signs for providing directions to at least one area, such as of a city. Each area-finder sign has a color code key, at least one color coded area title and a route description portion. The sign system also comprises a plurality of site-finder signs within each area for providing directions to at least one site. Each site-finder sign has a color code key. A site listing portion having a background color corresponding to the area which the site-finder sign is in and a directions portion. Preferably, the area-finder signs and site-finder signs are placed and sequenced according to a grid system. The grid system defines a plurality of portal locations, gateway locations and decision point intersections. The portal locations provide a way onto a means of access to another area. The area-finder signs provide directions to the portals. The gateway locations define an entrance into an area. They have a site-finder sign. The decision point intersections are located within a specific area and have at least one site-finder sign for providing direction to sites within the area. In a preferred embodiment, the color code key comprises a colored geographical icon of the areas with each area having a different color. The geographical icon is located on a top portion of each area-finder sign and each site-finder sign. The color coded area title of the area-finder signs can comprise a colored rectangle having a title of the area within. Preferably, the area-finder signs have a consistent background color such as the blue shown with the colored rectangles disposed thereon. The colors and type indentations are used to successively frame message elements to arrive at a simple “grammar” on the sign.

### FIELD OF THE INVENTION

The present invention is related in general to signs. More specifically, the present invention is related to a wayfinding sign system which has a hierarchial structure.

### BACKGROUND OF THE INVENTION

It is known to provide wayfinding signs in cities in order to provide directions to sites, such as coliseums and museums. For instance, Baltimore has trailblazer signs having pleasing design quality in the use of colors and shapes. The type is laid out legibly. The fact that there are 450 of the signs in the downtown area adds a festive air to the Baltimore streetscape. The “standardization” of height and location allows them to be recognizable. The Baltimore sign system is very straightforward: up to three sites are listed in a light blue area, underneath in a light green area is an arrow pointing the way. The signs say only one thing at a time: to get to these particular sites, go in this one direction.

Unfortunately, it is very difficult to deploy a plurality of wayfinder signs based merely on a set of cues based on individual destinations. Typically, there are serious gaps in the paths which the sign system lays out for drivers. The reason the paths break down is the mathematical complexity which necessarily arises when one attempts to build paths based on dozens of different cues on 450 signs. The problem of accounting for a driver in any given spot trying to get to any given destination is so complex, that the designers of wayfinder sign systems have relied on intuition and serious simplifying assumptions to make at least some routes work for some destinations.

If there are only three or four destinations, and thus only three or four different cues, then the wayfinding sign system will function very well. At any given “decision point” intersection, information can be provided for all destinations, so drivers would always know how to thread their way to their destination at any point in their routes. This is the case in San Francisco. San Francisco has trailblazer signs for Fisherman's Wharf, North Beach, Union Square, and Chinatown using colors and symbols on rectangular signs. Their design suffers in that the type is too small, symbols are too complex, and the use of existing irregularly spaced poles to hang the signs on.

The problem of wayfinding with more than just a few destinations poses a serous quandary. For instance, in a complicated city like Pittsburgh, there would be at least 50 destinations with an inevitable creep upwards as years go by. Creating pathways for the thousands of potential routes utilizing 50 destinations as cues 3 or 4 at a time will simply not work—it is a mathematical impossibility.

Upon analysis, it is discovered that a hierarchy in the set of destinations cues is needed. That is, if a wayfinding sign system is used to provide paths to any one of 50 destinations from any given spot in the city, and can only point continuously to say four things at a time, then destinations must be grouped under higher level categories.

The present invention proposes to wayfind first to areas (“area-finding”), such as in Pittsburgh, Downtown, the North Side, South Side, Oakland, and Highland Park. Then, within each area, individual sites can be listed (and as necessary, in subsets of four or five destinations at a time within wayfinding “islands” within a given “area”).

### SUMMARY OF THE INVENTION

The present invention is a hierarchical wayfinding sign system. The sign system comprises a plurality of area-finder signs for providing directions to at least one area, such as of a city. Each area-finder sign has a color code key, at least one color coded area title and a route description portion. The sign system also comprises a plurality of site-finder signs within each area for providing directions to at least one site. Each site-finder sign has a color code key, a site listing portion having a background color corresponding to the area which the site-finder sign is in and a directions portion.

Preferably, the area-finder signs and site-finder signs are placed and sequenced according to a grid system. The grid system defines a plurality of portal locations, gateway locations and decision point intersections. The portal locations are the entrances onto means of access to another area. The area-finder signs provide directions to the portals. The gateway locations define an entrance into an area itself. They have a site-finder sign. The decision point intersections are located within a specific area and have at least one site-finder sign for providing direction to sites within the area.

In a preferred embodiment, the color code key comprises a colored geographical icon of the areas with each area having a different color. The geographical icon is located on a top portion of each area-finder sign and each site-finder sign. The color coded area title of the area-finder signs can comprise a colored rectangle having a title of the area within. Preferably, the area-finder signs have a consistent background color, such as blue, with the colored rectangles disposed thereon.

The present invention pertains to a sign. The sign comprises a first portion which depicts a region and areas of the region. The sign also comprises a second portion which identifies at least area of the region depicted in the first portion. The second portion is connected with the first portion. The sign also comprises a third portion which identifies at least one location of an area of the region. The third portion is connected to the first portion. Preferably, the sign also comprises a fourth portion which provides direction to the location identified. The fourth portion is in contact with the third portion.

### BRIEF DESCRIPTION OF THE DRAWINGS

In the accompanying drawings, the preferred embodiment of the invention and preferred methods of practicing the invention are illustrated in which:

FIG. 1 is a schematic representation showing an area-finder sign and a site-finder sign located on a common post.

FIG. 2 is a schematic representation showing an area-finder sign.

FIG. 3 is a schematic representation showing a large site-finder sign.

FIG. 4 is a schematic representation showing a small site-finder sign.

FIG. 5 is a schematic representation showing a grid system on which placement and sequencing of the signs is based.

### DESCRIPTION OF THE PREFERRED EMBODIMENT

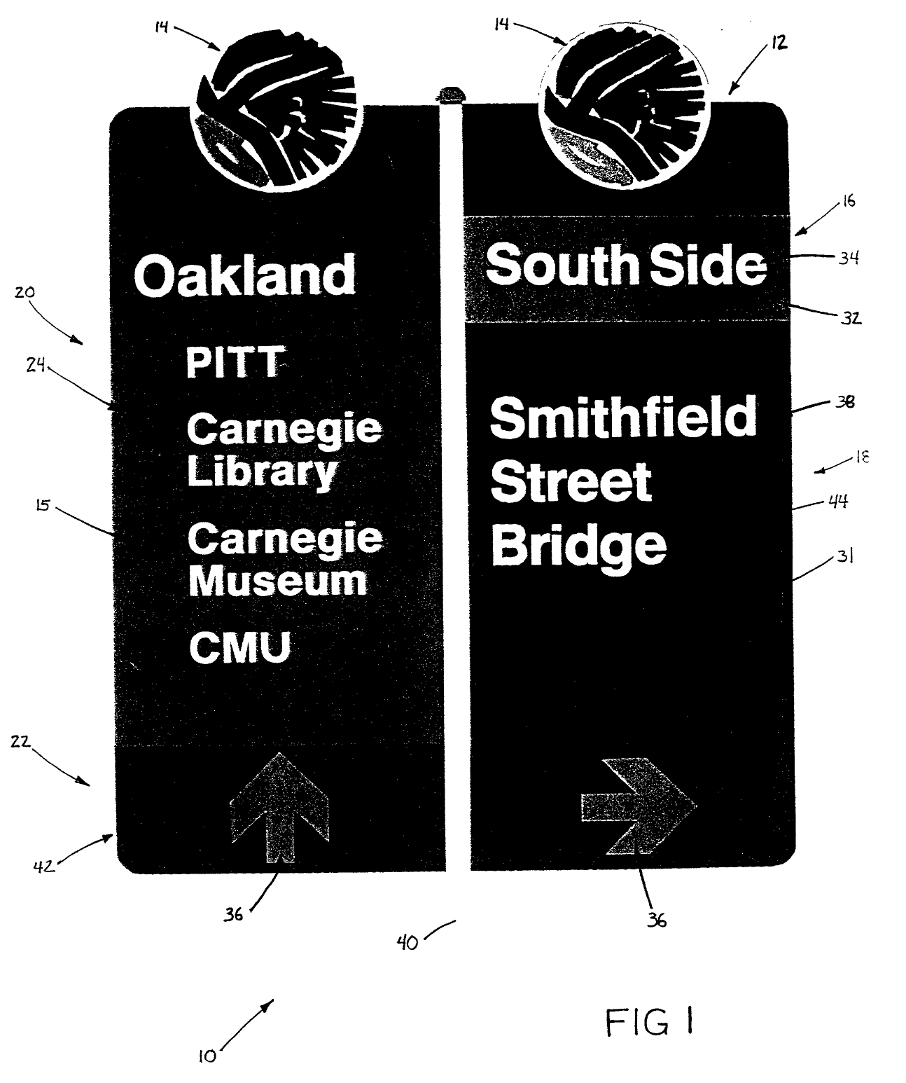

Referring now to the drawings wherein like reference numerals refer to similar or identical parts throughout the several views, and more specifically to FIG. 1 thereof, there is shown a hierarchical wayfinding sign system 10. The sign system 10 comprises a plurality of area-finder signs 12 for providing directions to at least one area, such as of a city. Each area-finder sign 12 has a color code key 14, at least one color coded area title 16 and a route description portion 18. The sign system 10 also comprises a plurality of site-finder signs 20 within each area for providing directions to at least one site. Each site-finder sign 20 has a color code key 14, a site listing portion 24 having a background color 15 corresponding to the area which the site-finder sign 22 is in and a directions portion 22.

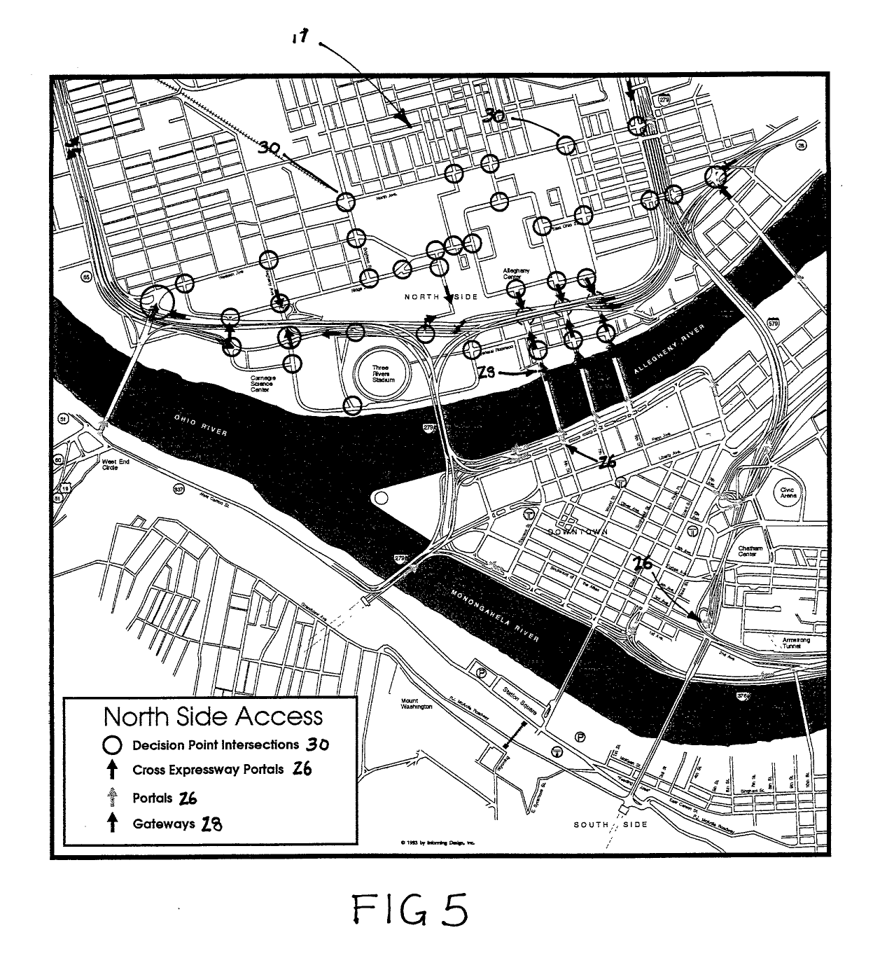

Preferably, as shown in FIG. 5, the area-finder signs 12 and site-finder signs 20 are placed and sequenced according to a grid system 19. The grid system 19 defines a plurality of portal locations 26, gateway locations 28 and decision point intersections 30. The portal locations 26 provide a way onto a means of access to another area. For instance, a portal location 26 can be an entrance to a bridge which connects to a route to another area. The area-finder signs 12 provide directions to the portals 26. The gateway locations 28 define an entrance into an area. They have a site-finder sign 20. The decision point intersections 30 are located within a specific area and have at least one site-finder sign 20 for providing direction to sites within the area.

In a preferred embodiment, the color code key 14 comprises a colored geographical icon of the areas with each area having a different color. The geographical icon is located on a top portion of each area-finder sign 12 and each site-finder sign 20. The color coded area title 16 of the area-finder signs 20 can comprise a colored rectangle 32 having a title 34 of the area within. Preferably, the area-finder signs 12 have a consistent background color 31, such as the blue shown, with the colored rectangles 32 disposed thereon.

The directions portion 22 of the site-finder signs 20 can comprise an arrow 36 disposed at a bottom portion 42 of the site-finder sign 20. In a similar manner, the route description portion 18 of each area-finder sign comprise a route listing 38 and an arrow 36. As shown in the figures, all the area-finder signs 12 and the site-finder signs 20 have a related shape for ease of identification.

Thus, the wayfinding sign system 10 is based on a hierarchy of cues. First, the person is directed to an area. Then, once in the area, the person can be directed to individual sites. The color code key 14 ties the whole system together.

The hierarchial structure of the sign system 10 does require users to have some knowledge that a particular site is in a particular area. However, a sign system is doomed if, on the surface, it aims to be effortless. That is, if the system points to individual destinations with the idea that a visitor won't have to know anything except to follow his destination's cue from one sign to the next, such a system cannot provide continuous paths with any degree of confidence. There would be too many millions of paths to account for. In a hierarchical system, someone might have to know that a particular sight is on the North Side, or that it is also in the direction of Allegheny Center and the Stadium, but this is not bad.

In order to construct an efficient sign system, each sign should convey its message in the simplest manner. Ironically, the hardest signs to read are long lists. The City of Baltimore recognized this and dealt with it by limiting their lists to three and by providing ample space between each listing. However, the trailblazer signs around Independence Hall in Philadelphia work badly. The type is thick and hard to read even a short distance away, and they provide too little space between listings. The Brandywine Valley sign system has each listing on a separate black bar, but still it is difficult to understand as one quickly passes by.

Why were such attempts at being as simple and straightforward as possible a failure? The humble fast food trailblazers on the interstates give a clue. There could be six very complicated multi-colored signs arrayed three by two on a big blue field, yet it is a reassuring and easy thing to follow. Interestingly enough, the Delaware Turnpike tampered with this system, and arrayed their restaurant signs irregularly and “fancily”, making them very difficult to understand at 55 miles per hour.

Thus, six very strange and different restaurant “logos”, many never seen before, on an interstate trailblazer sign, are simpler to understand than three or four of the simplest listings on a City trailblazer. This is because, when looking at a sign, one looks for “significance” or meaning of it. If a sign has four equal parts (that is, four equal listings), then one has to digest the meaning of a sign with four parts to it. There is no clear structure to the sign to tie the listings under a common visible heading. The listings are not differentiated in any way, so one has to go over it all to understand it. With interstate trailblazers, the big blue field is entitled “Food” and this gives one field, the world of food. It is easy to see that within that world, there are six possibilities. One can relax and wander over the complicated logos without worrying about the meaning of them. The sign is simply signifying the difference of one food possibility from another. Further, the listings must be precise in the regularity of its array. This is because any irregularity at that level introduces a new symbolic structure with unclear meaning.

Thus, with the site-finder signs 20, the background color 15 of the site-finding sign 20 is important. It conveys that the sites listed are in the area corresponding to that color, as shown in the color code key 14.

It should also be appreciated that the simplicity of a sign must be looked at not merely at the level of the simplicity of the lettering, but at the simplicity of its grammar. A sign with complication of two levels can actually introduce a relaxing degree of simplicity in meaning. For the wayfinding sign system 10, successive framing of elements is employed, sometimes with fields of color, sometimes with regular and meaningful variations in the placement of type. This creates a simplifying grammar for the signs which enables them to convey much more information at a given post than has been previously known or taught previously.

The present invention also pertains to a sign. This sign can be an area-finder sign 12 or a site-finder sign 20. The sign comprises a first portion which depicts a region and areas of the region. The first portion can be the color key 14 that is a graphic “flower”. The sign also comprises a second portion which identifies at least one area of the region depicted in the first portion. The second portion is connected with the first portion. The second portion can be the color coded area title 16 which is comprised of a colored rectangle 32. The sign also is comprised of a third portion which identifies at least one location of an area of the region. The third portion is connected to the second portion. The third portion can be a site listing portion 24 or a route description portion 18. Preferably, the sign also is comprised of a fourth portion which provides direction to the location identified. The fourth portion is in contact with the third portion. The fourth portion can be a bottom portion 42 which is comprised of an arrow 36. Preferably, the location identified in the third portion is in the area identified in the second portion.

In an example of the operation of the hierarchial wayfinding sign system 10, the sign system 10 is described as being used in Pittsburgh, Pa., having areas of North Side, South Side, Oakland, Highland Park, Downtown. Each color key 14 is a graphic “flower” on top of the signs to represent the three major rivers and five major areas of Pittsburgh in color. The five colors “code” the areas for the sign system 10, and are brushed as though by a painter into their areas of the circle. Each area of Pittsburgh is cued on an area-finder sign 12 with a rectangular color bar 32 reminiscent of the shape of Pittsburgh street signs. The background field 31 is the deep reflex blue of the rivers on the “flower”. This background field 31 will also serve as a base for supplemental information on the roads and bridges on the way to the color coded areas as well as for an intermediate level of district information (for example, Squirrel Hill, 2.0 Mi.). The color key 14 of the Pittsburgh flower will be on the top of each sign and will serve as a constant reminder of the color codes and as an identifying symbol of the wayfinder signs 12 and 20.

The signs will be hung on a post 40, preferably a post 40 that supports the signs from the side with the flexibility of having up to two signs per post, one hanging off of each side. This will allow, for example, for signs pointing to two directions at one location. The proportions of the signs (30″ wide by 6′ high in the “A” version) will give them the appearance of banners. Three different sign sizes for standard 25 to 35 mile per hour streets are proportioned to maintain the feeling of banners. Standardization of colors and shapes and letter application allows for mass production and keep costs to a minimum.

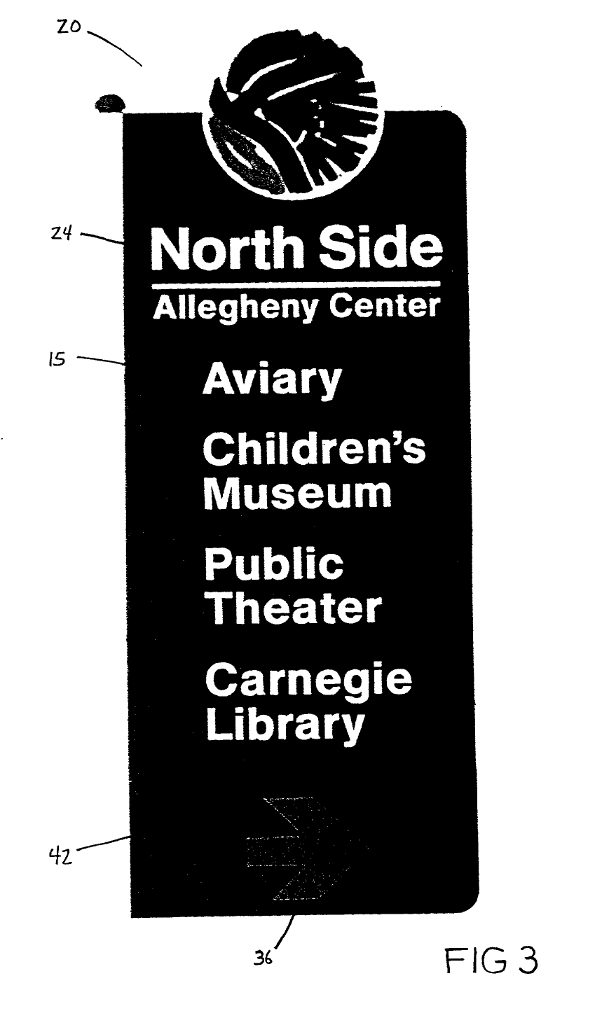

Referring to FIG. 3, each Site-finder sign 20 has a color 15 of its area on top, and will have a blue area on the bottom portion 42 for an arrow 36. In the color-coded area 15 is the listing of sites, or other information such as parking, pedestrian entrance, drop-off, and the like. There is a super heading of “North Side/Allegheny Center” in the font style of the Pittsburgh street signs. Below, indented, is the list of sites 24. The indentation serves a critical “framing” function.

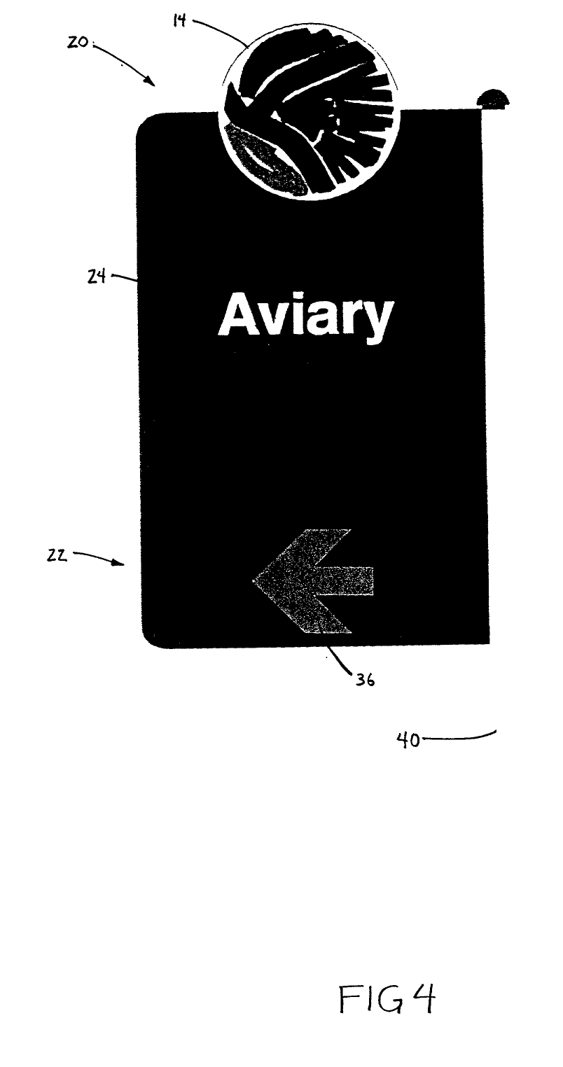

In cases where the listing 24 is of only one item, such as in FIG. 4, space is used to create the succeeding frame of information. The site-finder sign 20 of FIG. 4 is the smallest of the three standard sizes.

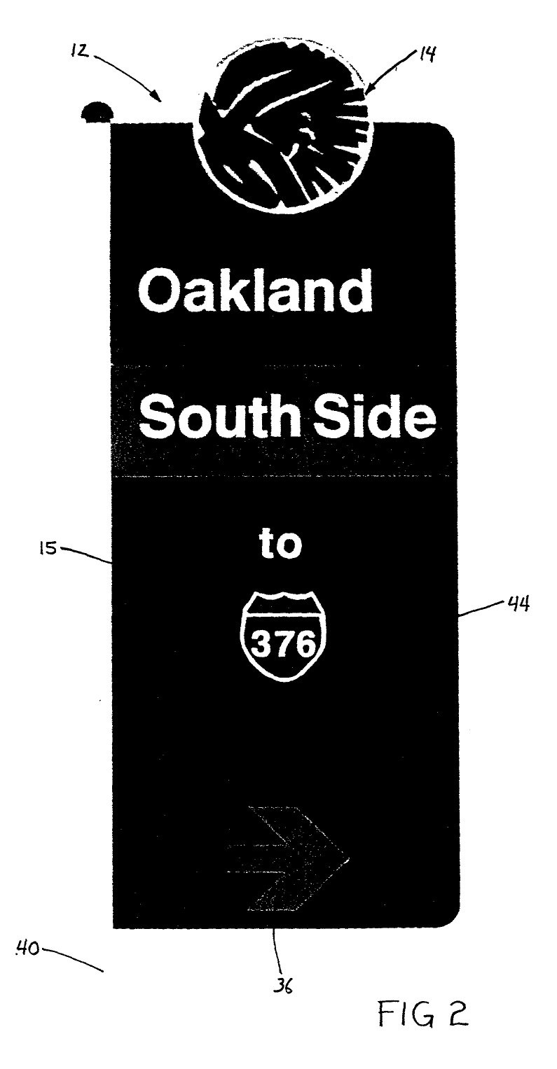

To make drivers feel comfortable getting around Pittsburgh, it is not enough to get them to a site. They need to get back out again, perhaps to another area of the City, or out altogether. The Area-finders signs 12 are “exit” signs as much as they are directional signs to the other areas. The area-finder signs 12 have an overall background field of reflex blue. In the top is placed the colored rectangle(s) 32 that correspond to the area(s) to which the signs are pointing. In blue underneath is the name 44 of the bridge or the route. In cases where the area-finding signs 12 are directing drivers out of the City and not into another area, the words can be simply printed as white letters on the blue field 31 instead of in a colored rectangle 32. The bottom part of the sign 12 is reserved for arrows 36 as for the site-finder signs 20. FIG. 2 shows an area-finder sign 12 pointing to two areas. FIG. 1 shows a double sign, one a site-finder sign 20 and the other an area-finder sign 12.

As shown in FIG. 5, a grid system is used as a basis for the sequencing of the signs. Each area is treated as an island. The area-finder signs 12 describe the means of access to that island from every other island. The way on to this means of access is called a portal location 26. An entrance point onto the island is called the gateway location 28. After entering the island, the site-finder signs 20 identify every intersection of interest, called a decision point intersection 30.

In general, signs should be used as sparingly as possible, consistent with good path building. Signs should never be facing traffic heading away from a site, area or portal location 26. Signs 20 by their very existence “tell” drivers that they are on their way. In addition, if there is more than one route possible at any given decision point intersection 30, the signs 20 point to one and only one direction. Ambiguity must be avoided. The best start to developing grid sequences is to identify particular traffic patterns, especially those that create confusion or problems.

In a specific example, a tourist wishing to visit the Aviary in the North Side area of Pittsburgh is directed by area-finder signs 12 to the North Side. The simplicity of the hierarchial sign system 10 requires that the tourist know that the Aviary is in the North Side. At the gateway 28 to the North Side, a site-finder sign 20, such as shown in FIG. 3, provides directions to the various sites of interest in the North Side. The tourist is directed to the Aviary through the North Side by the Site-finder signs 20 located at the various decision-point intersections 30.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A hierarchical wayfinding sign system comprising:
a plurality of area-finder signs for providing directions to at least one area, each area-finder sign having a color code key, at least one color coded area title and a route description portion; and
a plurality of site-finder signs within each area for providing directions to at least one site, each site-finder sign having a color code key, a site listing portion having a background color corresponding to the area and a directions portion.

2. A system as described in claim 1 wherein said area-finder signs and said site-finder signs placed and sequenced according to a grid system for the area to be found and the site to be found, said grid system defining a plurality of portal locations, gateway locations and decision point intersections, said portal locations providing a way onto a means of access to another area with said area-finder signs providing directions to the portals, said gateway locations defining an entrance into an area and having a site-finder sign, said decision point intersections located within a specific area and having at least one site-finder sign for providing directions to sites within the area.

3. A wayfinding sign system as described in claim 2 wherein the color code key comprises a colored geographical icon of the areas with each area having a different color, said geographical icon located on a top portion of each area-finder sign and each site-finder sign.

4. A wayfinding sign system as described in claim 3 wherein the color coded area title of the area-finder signs comprise a colored rectangle having a title of the area within.

5. A wayfinding sign system as described in claim 4 wherein the area-finder signs have a consistent background color with the colored rectangles disposed thereon.

6. A wayfinding sign system as described in claim 5 wherein the directions portion of the site-finder signs comprises an arrow disposed at a bottom portion of the site-finder sign.

7. A wayfinding sign system as described in claim 6 wherein the route description portion of each area-finder sign comprises a route listing and an arrow.

8. A wayfinding sign system as described in claim 7 wherein all the area-finder signs and the site-finder signs have a related shape for ease of identification.

9. A wayfinding sign system as described in claim 8 wherein the area-finder signs and site-finder signs utilize successive framing of elements to create a simple sign grammar format and thus convey more information than is possible utilizing simple lists.

10. A sign comprising:
a first portion which depicts region and areas of the region;
a second portion which identifies at least one area of the region depicted in the first portion, said second portion connected with the first portion; and
a third portion which identifies at least one location of an area of the region, said third portion connected to said second portion.

11. A sign as described in claim 10 including a fourth portion which provides direction to the location identified, said fourth portion in contact with said third portion.

12. A sign as described in claim 11 wherein the fourth portion includes an arrow pointing the direction to the location.

13. A sign as described in claim 12 wherein the location identified in the third portion is in the area identified in the second portion.

14. A method of wayfinding comprising the steps of:
guiding a user to a specific area with an area finder sign having a color coded area title; and
directing a user within the area to a specific site in the area with a site-finder sign having at least one site listing on a color coded background corresponding to the area.

15. A method as described in claim 14 wherein before the guiding step, there is the step of placing the area-finder signs and site-finder signs in a sequence according to a grid system for the area to be found and the site to be found, said grid system defining a plurality of portal locations, gateway locations and decision point intersections, said portal locations providing an entrance onto a means of access to another area with said area-finder signs providing directions to the portals, said gateway locations defining an entrance into an area and having a site-finder sign, said decision point intersections located within a specific area and having at least one site-finder sign for providing directions to sites within the area.
